(19) United States
(12) Patent Application Publication
(10) Pub. No.: US 2015/0128066 A1
(43) Pub. Date: May 7, 2015

(54) SYSTEM AND METHOD FOR CUSTOMIZING A DISPLAY OF A USER DEVICE

(71) Applicant: Doat Media Ltd., Tel Aviv (IL)

(72) Inventors: Joey Joseph Simhon, Ramat-Gan (IL); Amir Taichman, Haifa (IL); Dvir Volk, Tel Aviv (IL); Amihay Ben-David, London (GB); Fade Rudnitsky, Tel Aviv (IL)

(73) Assignee: Doat Media Ltd., Tel Aviv (IL)

(21) Appl. No.: 14/594,346

(22) Filed: Jan. 12, 2015

Related U.S. Application Data
(63) Continuation-in-part of application No. 13/296,619, filed on Nov. 15, 2011.
(60) Provisional application No. 61/927,546, filed on Jan. 15, 2014.

(51) Int. Cl. G06F 3/0484; G06F 17/30

(52) U.S. Cl. CPC G06F 3/04842; G06F 17/30867
USPC 715/747

(57) ABSTRACT

A system and method for adaptively customizing a display of a user device. The method comprises receiving, from the user device, at least one variable; analyzing the at least one variable; generating a current user profile based on at least the analysis of the at least one variable; searching for at least one display item based on the current user profile; generating, based on the at least one display item, a customized display of the user device; and customizing a display of the user device according to the customized display, wherein the display is adaptively customized upon identification a change in the received at least one variable.

### CROSS-REFERENCE TO RELATED APPLICATIONS

This application claims the benefit of U.S. Provisional Application No. 61/927,546 filed on Jan. 15, 2014, the contents of which are hereby incorporated by reference. This application is also a continuation-in-part of U.S. patent application Ser. No. 13/296,619 filed on Nov. 15, 2011, now pending, the contents of which are hereby incorporated by reference.

### TECHNICAL FIELD

The present disclosure relates generally to searching for content through the web in respective of variables collected by a user device, and more specifically to customizing a display of the user device respective of the collected variables.

### BACKGROUND

Home screens are typically used to navigate through content on computing devices of users. Navigation through the home screen may be carried out by pressing navigation keys on the user's device or by manipulating other input devices (e.g., a touch screen placed over a display of the user's device) that are associated with the device.

The home screen usually includes a plurality of icons that are static in nature and may be moved from one static display of icons to another by the user. Further, the display screens of some user devices (e.g., smartphones and tablet computers) are very limited in size compared to the display screens of larger devices (e.g., desktop and laptop computers).

On a handheld computing device, the home screen typically operates as a default browser which displays static data that usually fits the variety of data streaming to and from the mobile device. The home screen usually includes icons associated with applications as well as icons associated with documents, files, and so on. The icons may be arranged according to users' preferences, but once the icons are set, the home screen typically cannot be dynamically changed to display a different set of icons that are not previously configured by the user.

Existing solutions for changing the home screen of a user device typically permit the user to alter the arrangement of icons on the home screen at will. However, these methods require the user to manually change the icons, forcing the user to cease conducting the users' activities normal activities to alter the home screen. This cessation may be time-consuming when conducted frequently, and is typically highly disruptive to the user. Further, existing solutions that modify the home screen based on information regarding the user and/or the user's environment do not account for recurring tendencies of the user.

It would therefore be advantageous to provide an efficient solution for providing an adaptive home screen. It would be further advantageous if such a solution could adapt the home screen based on tendencies of the user.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

The disclosed embodiments include a method for adaptively customizing a display of a user device. The method comprises receiving, from the user device, at least one variable; analyzing the at least one variable; generating a current user profile based on at least the analysis of the at least one variable; searching for at least one display item based on the current user profile; generating, based on the at least one display item, a customized display of the user device; and customizing a display of the user device according to the customized display, wherein the display is adaptively customized upon identification a change in the received at least one variable.

The disclosed embodiments also include a system for adaptively customizing a display of a user device. The system comprises a processor; and a memory, the memory containing instructions that, when executed by the processor, configure the system to: receive, from the user device, at least one variable; analyze the at least one variable; generate a current user profile based on at least the analysis of the at least one variable; search for at least one display item based on the current user profile; generate, based on the at least one display item, a customized display of the user device; and customize a display of the user device according to the customized display, wherein the display is adaptively customized upon identification a change in the received at least one variable

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a network system utilized to describe the various embodiments for generating adaptive home screens according to an embodiment;

FIG. 2 is a schematic diagram of an agent installed on a user device utilized to customize the display of a user device according to an embodiment; and

FIG. 3 is a flowchart illustrating a method for customizing the display of a user device according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

By a way of example for the disclosed embodiments, a method and system for adaptively updating a display of a user device are provided. In an exemplary embodiment, the display is updated with customized content items based on a user profile generated respective of one or more variables related to the user. The variables are either personal or environmental, and may be collected by sensors of the user device. The display of the user device may be further updated based on content items that exist on the user device. A customized display is selected for the display of the user device respective of the user profile. Then, the display on the screen of the user device is respectively customized. Upon receiving one or more newly environmental variables, the display of the user device is adaptively updated.

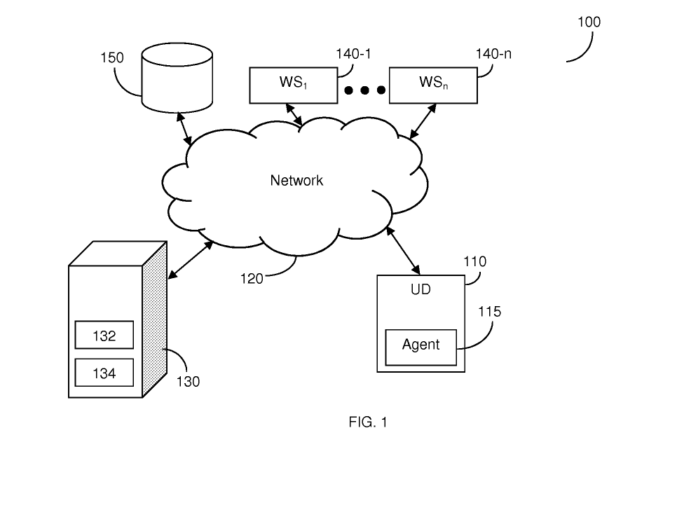

FIG. 1 shows an exemplary and non-limiting schematic diagram of a network system 100 utilized to describe the various disclosed embodiments. A user device 110 is connected to a network 120. The user device 110 may be a smartphone, a mobile phone, a laptop, a tablet computer, a wearable computing device, a personal computer (PC), a smart television, and the like. The network 120 may be a local area network (LAN), a wide area network (WAN), a metro area network (MAN), the Internet, the worldwide web (WWW), a wireless network, a wired network, a cellular network, a combination thereof, and so on.

In accordance with one embodiment, a server 130 is also connected to the network 120. The server 130, in one embodiment is configured to receive one or more variables, environmental or personal, related to a user of the user device 110. An environmental variable is generally a variable which a user has no control over. The environmental variables may be, but is not limited to, a location of the user device 110, a rate of motion of the user device 110, weather information, a sound, an image, a time of day, and so on. The personal variables may be, but are not limited to, a user profile on a website, a user's age, demographic information related to a user, information related to the user device 110, information related to a user's web accounts, and so on. In an embodiment, the server 130 may be preconfigured to include a set of variables defined by the system 100 and/or by the user.

The server 130 is further configured to identify content items that exist on the user device 110. The content items may be, but are not limited to, data items installed on the user device 110, application programs existing on the user device 110, application programs existing over the web that are accessed by the user device 110, photos and video clips saved in the user device 110, and so on. According to one embodiment, the identification is assisted by an agent 115 installed on the user device 110. In such an embodiment, the server may, e.g., provide a query to the agent 115 that will yield a content item. The user device 110 further comprises one or more sensors (not shown) by which the environmental variables are collected. The sensors may be, for example, a global positioning system (GPS), a still camera, a video camera, speech recognizer, a temperature meter, a motion sensor, and the like.

The server 130 is configured to analyze the received variables and the identified content items. Respective of the analysis, the server 130 is configured to generate a current user profile for the user of the user device 110. In an exemplary embodiment, the current user profile represents characteristics of the user and his/her environment. The current user profile may include characteristics indicating, for example, the user's interests, the user's schedule, the user's travel frequency, the user's profession, and so on. The current user profile may also include information related to environmental and/or personal variables. For example, a current user profile may indicate that a particular user tends to be awake from 6 A.M. to 10 P.M. each day, that the user travels to work each morning and returns home in the evening, that the user attends certain activities throughout the week (e.g., visiting a friend's house on Saturdays), that the user is interested in playing a sport (e.g., golf, tennis, etc.), and so on. For example, a current user profile may indicate whether the user is awake, the current location of the user, whether the user is at a significant location related to the user (e.g., place of work, homes of friends and family, stores frequented by the user, and the like), a time, any hobbies or interests of the user (e.g., movies and television shows, sports, and hobbies), and so on.

The current user profile enables the server 130 to characterize the user of the user device 110 at a certain time and, therefore, the server 130 can provide content to the user device 110 that matches the user's needs and requirements at that certain time. Specifically, the server 130 can identify portions of the current user profile that related to one or more current variables to determine which content would be appropriate to the user at this time. As a non-limiting example, if the current user profile indicates that the user likes to eat Sushi while the current variables indicate that the user is away from home and that it is 12:00 P.M., the server 130 may determine that the user would be interested in finding a restaurant to eat Sushi at and, as a result, finds a GPS content item on the user device that is capable of finding such a restaurant.

According to one embodiment, the current user profile is generated based on one or more profile patterns existing in a database 150. A profile pattern is a predetermined user profile associated with a variety of variables and/or content items. The profile pattern represents a tendency of the user. The profile patterns are analyzed and matched to the at least one variable and to the content items. As a non-limiting example, a profile pattern “night owl” may be associated with the environmental variables “between the hours of 11 P.M. and 4 A.M.” and “away from home” when a combination of those variables is detected at least two times in the last week. As such, if a user turns the user device on at 12 A.M. while away from the user's home every day, it may be determined that the user frequently stays awake late at night and, as a result, the profile pattern will include an indication of this tendency. Thus, at night, the home screen may be customized to provide, for example, applications (e.g., a maps application directing the user to a nearby coffee shop that is open) or reminders (e.g., a reminder that the user should go to sleep).

Based on the current user profile, the server 130 is configured to customize a display of the user device 110. The customization includes modifying at least one display item such as, but not limited to, a wallpaper, one or more widgets, one or more icons, and so on. In an embodiment, when customization includes modifying a wallpaper the wallpaper may be instantly updated as described in the above-mentioned U.S. patent application Ser. No. 13/296,619, the contents of which are hereby incorporated by reference.

In an embodiment, the display item is an item to be displayed on the user device. The display items may be selected from among the content items identified on the user device and/or from content items existing over the web accessible by the user device. As a non-limiting example, if two wallpapers are present on a user device, one of the wallpapers which best suits the current user profile may be selected to be displayed on the user device. An icon may be any type of graphical symbol rendered and displayed over the display on the user device. Clicking or tapping on an icon activates an app or provides a link to an information resource (e.g., news website), thereby providing the user with the desired information and/or action. Modification may include, but is not limited to, selecting display items, selecting positions of display items, customizing the appearance of display items, and so on. The selection of the display items may be performed through a plurality of web sources 140-1 through 140-n.

According to another embodiment, the at least one display item is extracted from the database 150. The at least one display item may include images, videos, links to content, and so on. The server 130 then customize the display of the user device 110 with the selected at least one display item. Upon receiving one or more additional variables and/or detecting a change in content items accessed by the user, the server 130 adaptively customizes the display of the user device 110 respective thereto. The selected content are stored in the database 150 for further use.

As a non-limiting example, the user device 110 is identified as currently located in Amsterdam, Netherlands. The content existing on the user device 110 indicates that the user is a photographer and that the user's home address is in New York, N.Y., USA. Respective of the current location, content related to Amsterdam is selected to be a displayed item through one or more web sources 140. In addition, data related to one or more photography galleries in Amsterdam is extracted from a web source 140. The display of the user device 110 is then customized with the selected display items.

The server 130 typically includes a processing unit 132 and a memory 134, the memory 134 containing instructions to be executed by the processing unit 132. The processing unit 132 may comprise, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 132 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing unit, cause the processing unit to perform the various functions described herein.

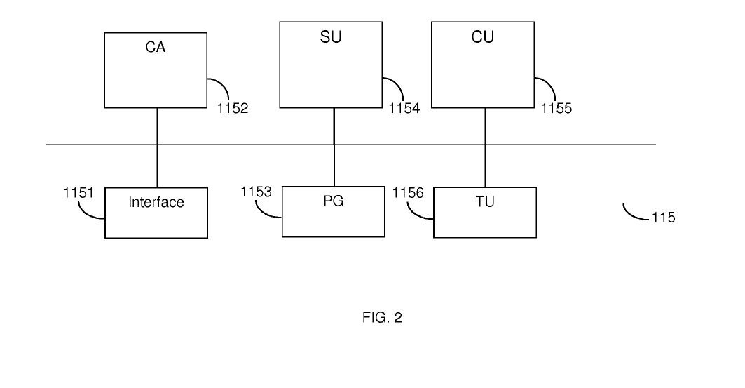

FIG. 2 depicts an exemplary and non-limiting schematic diagram of the agent 115 installed on the user device 110. The agent 115 includes an interface 1151 through which the agent 115 receives variables collected respective of the user of the user device 110. The agent 115 further includes a content analyzer (CA) 1152. The content analyzer 1152 is configured to identify content existing on the user device 110. The content analyzer 1152 is further configured to analyze the content existing on the user device 110 and the one or more variables.

The agent 115 further comprises a profile generator (PG) 1153. In an embodiment, the PG 1153 is configured to analyze the content existing on the user device 110 and the collected variables and generate a current user profile based on the analysis. The agent also includes a searching unit 1154 (SU) configured to search for display items respective of the current user profile. The content identified by the searching unit 1154 is used by a customization unit (CU) 1155 for customizing the display of the user device 110.

In an embodiment, the agent may further comprise a tracking unit 1156 which continuously tracks changes in the one or more variables and/or the content existing on the user device 110. Upon detection of a change, the tracking unit 1156 may provide a notification to the profile generator 1153. Upon receipt of this notification, the profile generator 1153 will typically generate a new current user profile respective of the changed variables and/or content.

In a further embodiment, the tracking unit 1156 may be configured to determine whether a detected change is significant. A detected change is significant if, for example, it exceeds a predefined threshold. In an embodiment, the significance requirement is met if the detected change exceeds a predefined threshold. In that embodiment, the notification is only provided to the profile generator 1153 if the detected change is significant. This determination of significance prevents minor changes from causing frequent generations of displays which would unnecessarily waste computing resources and disrupt the user's experience. The various units of the agent 115 can be implemented in hardware, software, microcode, firmware or any combination thereof.

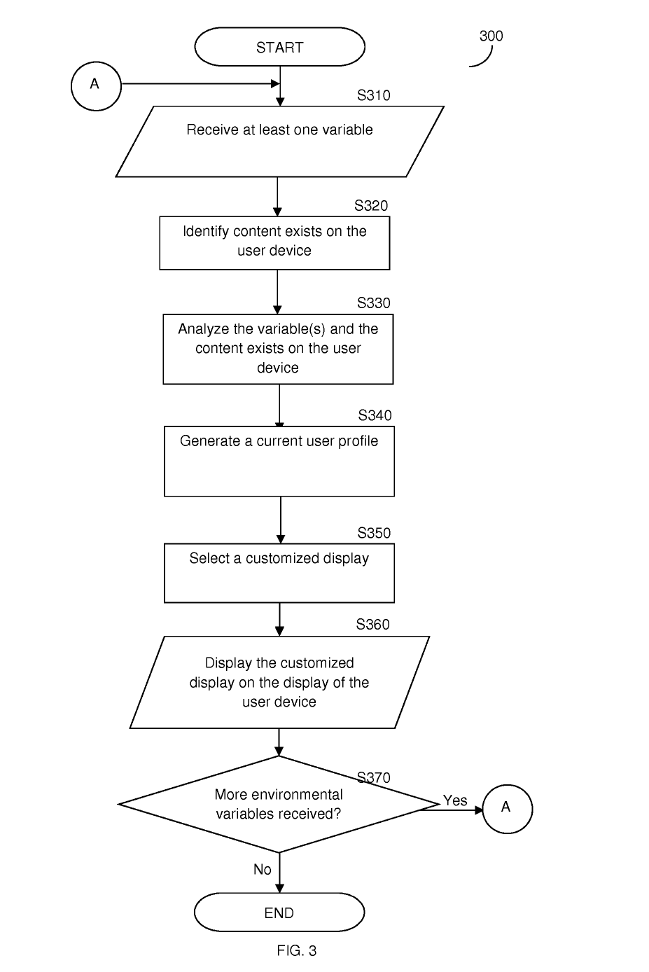

FIG. 3 depicts an exemplary and non-limiting flowchart 300 of a method for customizing a display of a user device according to an embodiment. In S310, at least one variable is received from a user device (e.g., the user device 110). In an embodiment, the at least one variable may be preconfigured to include a set of variables defined by the user. The at least one variable may be an environmental variable or a personal variable.

An environmental variable may be, for example and not by way of limitation, the location of the user device, previously submitted queries, the device rate of motion, a time of day, and more. The environmental variable may be received from a sensor that is part of the user device, a database, or by monitoring the user activity on the user device An environmental variable is generally a variable which a user has no control over. The environmental variables may be, but is not limited to, a location of the user device, a rate of motion of the user device, weather information, a sound, an image, a time of day, and so on. A personal variable may be, but is not limited to, a profile on a website, a user's age, demographic information related to a user, information related to the user device 110, information related to a user's web accounts, and so on. Such variables may be retrieved or received from systems and databases that generate and/or maintain the variables.

In S320, at least one content item existing on the user device is identified. The at least one content item may be, but is not limited to, a data item installed on the user device, an application program existing on the user device, an application program existing over the web that is accessed by the user device, and so on. In S330, at least one variable and the at least one content item existing on the user device are analyzed.

In S340, a current user profile is generated respective of the analysis. In an exemplary embodiment, the current user profile represents characteristics of the user and of his/her environment. The current user profile may include characteristics indicating, for example, the user's interests, the user's schedule, the user's travel frequency, the user's profession, and so on. The current user profile may also include information related to environmental and/or personal variables. For example, a current user profile may indicate whether the user is awake, the current location of the user, whether the user is at a significant location related to the user (e.g., place of work, homes of friends and family, stores frequented by the user, and the like), a time, any hobbies or interests of the user (e.g., movies and television shows, sports, and hobbies), and so on.

The current user profile may be based on one or more profile patterns existing in a database. A profile pattern is a predetermined user profile associated with a variety of variables and/or content items. The profile patterns are analyzed and matched to the at least one variable and to the content items. As a non-limiting example, a profile pattern “night owl” may be associated with the environmental variables “between the hours of 11 P.M. and 4 A.M.” and “away from home” when a combination of those variables is detected at least two times in the last week. As such, if a user turns the user device on at 12 A.M. while away from the user's home every day, it may be determined that the user frequently stays awake late at night and, accordingly, the profile pattern will include an indication of this tendency. Thus, at night, the home screen may be customized to provide, for example, applications (e.g., a maps application directing the user to a nearby coffee shop that is open) or reminders (e.g., a reminder that the user should go to sleep).

In S350, a display of the user device is customized based on the user profile. The customization may include selecting and/or modifying, for example, a wallpaper, widgets, icons, and so on. In an embodiment, when customization includes modifying a wallpaper the wallpaper may be instantly updated as described in the above-mentioned U.S. patent application Ser. No. 13/296,619, the contents of which are hereby incorporated by reference.

In S360, a customized display is displayed on the display of the user device. In S370, it is checked whether additional variables have been identified or if the variables previously received have been changed. If so, execution continues with S310; otherwise, execution terminates. In an embodiment, an additional variable is identified only if it is significant. An additional variable is significant if, for example, a detected change between the additional variable and a comparable previously received variable exceeds a predefined threshold. A previously received variable is comparable to an additional variable if the previously received variable and the additional variable are the same type of variable. As a non-limiting example, two sets of geographical location coordinates would be the same type of variable. The method disclosed herein with respect to FIG. 3 can be implemented by the server 130 and/or by any agent 115 installed in the user devices.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for adaptively customizing a display of a user device, comprising:
receiving, from the user device, at least one variable;
analyzing the at least one variable;
generating a current user profile based on at least the analysis of the at least one variable;
searching for at least one display item based on the current user profile;
generating, based on the at least one display item, a customized display of the user device; and
customizing a display of the user device according to the customized display, wherein the display is adaptively customized upon identification a change in the received at least one variable.

2. The method of claim 1, further comprising:
identifying at least one content item existing on the user device;
analyzing the at least one content item, wherein generating the current user profile is further based on the analysis of the at least one content item;
upon identification of a change in the at least one content item, adaptively customizing the display of the user device.

3. The method of claim 1, wherein the at least one variable is at least one of: an environmental variable, and a personal variable.

4. The method of claim 1, wherein the current user profile is generated respective of a profile pattern stored in a database.

5. The method of claim 1, wherein generating the customized display further comprises:
modifying the at least one display item on the customized display of the user device.

6. The method of claim 5, wherein the at least one display item is at least any one of: a wallpaper, a widget, and an icon.

7. The method of claim 5, wherein modifying the at least one display item on the customized display of the user device further comprises at least one of: selecting the at least one display item, selecting at least a position of the at least one display item, and customizing an appearance of the at least one display item.

8. The method of claim 4, wherein generating the current user profile further comprises:
extracting the at least one profile pattern from the database;
analyzing the at least one profile pattern to determine a match between a profile pattern of the at least one profile pattern with the at least one variable and the at least one content item; and
generating the current user profile respective of the match.

9. The method of claim 3, further comprising:
tracking a change in any of: the at least one variable, and the at least one content item.

10. The method of claim 9, further comprising:
determining whether the tracked change is significant; and
upon determining that the tracked change is significant, adaptively customizing the display of the user device.

11. A non-transitory computer readable medium having stored thereon instructions for causing one or more processing units to execute the method according to claim 1.

12. A system for adaptively customizing a display of a user device, comprising:
a processor; and
a memory, the memory containing instructions that, when executed by the processor, configure the system to:
receive, from the user device, at least one variable;
analyze the at least one variable;
generate a current user profile based on at least the analysis of the at least one variable;
search for at least one display item based on the current user profile;
generate, based on the at least one display item, a customized display of the user device; and
customize a display of the user device according to the customized display, wherein the display is adaptively customized upon identification a change in the received at least one variable.

13. The system of claim 12, wherein the system is further configured to:
identify at least one content item existing on the user device;
analyze the at least one content item, wherein generating the current user profile is further based on the analysis of the at least one content item;
upon identification of a change in the at least one content item, adaptively customize the display of the user device.

14. The system of claim 12, wherein the at least one variable is at least one of: an environmental variable, and a personal variable.

15. The system of claim 12, wherein the current user profile is generated respective of a profile pattern stored in a database.

16. The system of claim 12, wherein the system is further configured to:
modify the at least one display item on the customized display of the user device.

17. The system of claim 16, wherein the at least one display item is at least any one of: a wallpaper, a widget, and an icon.

18. The system of claim 16, wherein modifying the at least one display item on the customized display of the user device further comprises at least one of: selecting the at least one display item, selecting at least a position of the at least one display item, and customizing an appearance of the at least one display item.

19. The system of claim 15, wherein the system is further configured to:
extract the at least one profile pattern from the database;
analyzing the at least one profile pattern to determine a match between a profile pattern of the at least one profile pattern with the at least one variable and the at least one content item; and
generate the current user profile respective of the match.

20. The system of claim 14, wherein the system is further configured to:
tracking a change in any of: the at least one variable, and the at least one content item.

21. The system of claim 20, wherein the system is further configured to:
determine whether the tracked change is significant; and
upon determining that the tracked change is significant, adaptively customize the display of the user device.
